(19) United States
(12) Patent Application Publication
(10) Pub. No.: US 2007/0173993 A1
(43) Pub. Date: Jul. 26, 2007

(54) Method and system for monitoring fleet metrics

(76) Inventors: Benjamin J. Nielsen, Lakeville, MN (US); Jon Passman, Minnetonka, MN (US); Stephen Tenzer, Prior Lake, MN (US)

Correspondence Address: DRINKER BIDDLE & REATH;ATTN: INTELLECTUAL PROPERTY GROUP, ONE LOGAN SQUARE, 18TH AND CHERRY STREETS, PHILADELPHIA, PA, 19103-6996, US

(21) Appl. No.: 11/337,913

(22) Filed: Jan. 23, 2006

(51) Int. Cl. G01M 17/00; G06F 19/00

(52) U.S. Cl. 701/35; 701/29

(57) ABSTRACT

Monitoring an actionable metric associated with a fleet is disclosed. A first data set is received that includes fleet management data for the fleet. A second data set is received that includes field service data associated with the fleet. A third data set is received that includes vehicle diagnostic data and/or vehicle positioning data. A performance indicator is calculated using data elements associated with at least two of the three data sets. An actionable metric is reported, based upon the performance indicator.

### FIELD OF THE INVENTION

This invention relates to a method and system for monitoring an actionable metric associated with a fleet of vehicles.

### BACKGROUND OF THE INVENTION

Companies use fleets of vehicles for purposes that include delivering products, selling products, and servicing products (e.g., transporting personnel such as field service technicians to provide services at customer sites). As fleet operators, these companies are generally concerned with efficient management of their fleets, as well as associated fleet assets such as personnel resources and inventory, in ways that will reduce or control costs and enhance profitability. Fleet operators may manage the fleets themselves, or may outsource fleet management tasks to an outside fleet manager, such as a fleet services provider that may manage, lease, and/or service the vehicles.

Computerized tools for fleet management have long been available to store and report general information about vehicles and other fleet assets. For example, conventional fleet management systems that analyze the use of vehicles within a fleet are generally limited to analyzing basic usage parameters of a vehicle based upon sensor readings that are made on the vehicle. For example, a conventional telematics system may measure basic parameters such as the speed of the vehicle or the location of a vehicle, or may capture on-board diagnostic information from a vehicle. Such information may be relayed to a database or a server where it may be accessed by an interested party such as a fleet manager.

In addition, various field services systems exist for routing and scheduling the movement of vehicles and personnel resources associated with a fleet. Such systems can assist a fleet manager in using vehicles in the fleet in a relatively efficient manner, often related to reducing manpower costs for providing services at customer sites. However, field services systems have not been provided to fleet managers as part of a system that integrates field service data with vehicle telematics (such as vehicle diagnostic data and positioning data), and fleet management data.

### SUMMARY OF THE INVENTION

Methods and systems for monitoring fleet metrics are provided. In an illustrative implementation, a method for monitoring an actionable metric associated with a fleet comprises receiving a first data set that includes fleet management data for the fleet. In the illustrative implementation, a second data set is received that includes field service data associated with the fleet, and a third data set is received that includes vehicle diagnostic data and/or vehicle positioning data. A performance indicator is calculated in the illustrative implementation, using data elements associated with at least two of the three data sets. An actionable metric is reported in the illustrative implementation, based upon the performance indicator.

Additional objects, advantages and novel features of the invention will be set forth in part in the description, examples and figures which follow, and in part will become apparent to those skilled in the art on examination of the following, or may be learned by practice of the invention.

### BRIEF DESCRIPTION OF THE DRAWINGS

For the purpose of illustrating the herein described systems and methods, drawings are provided with the understanding, however, that the herein described system and methods are not limited to the precise arrangements and instrumentalities shown.

FIG. 1 is a block diagram of a prior art exemplary computing environment suitable for practicing an embodiment of the invention;

FIG. 2 is a diagram showing the cooperation of components of an exemplary prior art network environment suitable for practicing an embodiment of the invention;

FIG. 3 is a diagram illustrating a relationship between exemplary fleet assets and exemplary data sets for an embodiment of the invention.

FIG. 4 is a diagram illustrating an exemplary system architecture for an embodiment of the invention.

FIG. 5 shows an exemplary user interface for a portal in an embodiment of the invention.

FIG. 6 shows an exemplary actionable metric displayable by a portal in an embodiment of the invention.

FIG. 7 shows an exemplary alert and exception displayable by a portal in an embodiment of the invention.

FIG. 8 shows an exemplary detail screen displayable by a portal in an embodiment of the invention.

FIG. 9 shows an exemplary detail screen associated with an exception report for an exception, displayable by a portal in an embodiment of the invention.

FIG. 10 shows an exemplary detail screen associated with an asset listing for fleet assets, displayable by a portal in an embodiment of the invention.

FIG. 11 shows an exemplary detail screen associated with a selected fleet asset, displayable by a portal in an embodiment of the invention.

FIG. 12 shows an exemplary detail screen associated with trip mapping for a selected fleet asset, displayable by a portal in an embodiment of the invention.

FIG. 13 is a flow chart of a method according to an embodiment of the present invention.

### DETAILED DESCRIPTION

Overview

Companies that operate fleets, in recognizing the importance of the fleet assets to their core business processes, may desire an integrated solution that can improve fleet profitability. Using aspects of the herein described systems and methods, the ability to monitor performance indicators can provide opportunities for a fleet manager to increase fleet profitability for the fleet operator. Improving fleet profitability can include, for example, reducing fleet operating costs, increasing labor productivity, reducing labor costs, and reducing costs associated with operating a vehicle. Aspects of the invention can provide actionable metrics to inform business decisions.

For example, by providing performance indicators and actionable metrics, aspects of the present invention can equip a fleet manager to better address issues such as enhancing mobile workforce productivity to produce more revenue per driver, enhancing fleet asset productivity to reduce operating costs per vehicle, and enhancing safety and security of fleet assets (e.g., vehicles, employees, inventory) to reduce risk of losses. In some embodiments, business needs such as revenue growth can be addressed by strategies to increase customer satisfaction and retention, cost savings can be addressed by strategies to improve fleet and service delivery productivity, and risk reduction can be addressed by strategies to improve compliance, safety, and security.

In an illustrative embodiment of the invention, a computer-implemented fleet monitoring system can integrate and provide web-based reporting using sets of data such as vehicle positioning data (e.g., Global Positioning System (GPS) and the like), vehicle diagnostic data (e.g., data originating from on-board diagnostic technology in vehicles), field service data, and fleet management data. These and other data sets may in some embodiments be received from one or more outside vendors or providers, such as a telematics provider, a field services provider, and a fleet management provider; in other embodiments, the fleet manager may provide one or more of the data sets that are received by the fleet monitoring system.

Illustrative Computing Environment

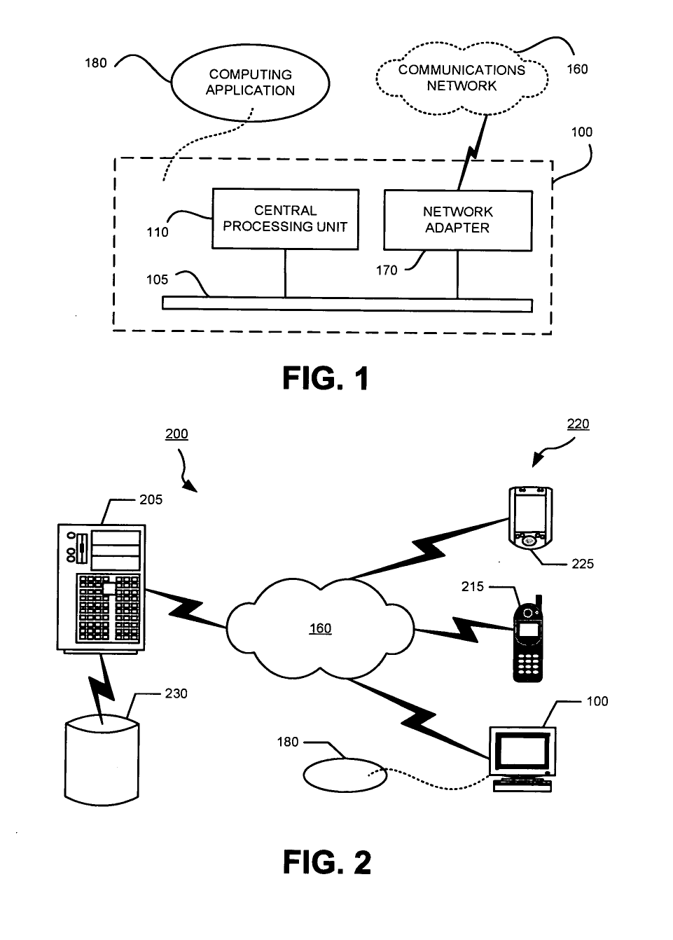

Referring to the drawings, in which like reference numerals indicate like elements, FIG. 1 depicts an exemplary computing system 100 in accordance with herein described systems and methods. The computing system 100 is capable of executing a variety of computing applications 180. Computing application 180 can comprise a computing application, a computing applet, a computing program and other instruction set operative on computing system 100 to perform at least one function, operation, and/or procedure. Exemplary computing system 100 is controlled primarily by computer readable instructions, which may be in the form of software. The computer readable instructions can contain instructions for computing system 100 for storing and accessing the computer readable instructions themselves. Such software may be executed within central processing unit (CPU) 110 to cause the computing system 100 to do work. In many known computer servers, workstations and personal computers CPU 110 is implemented by micro-electronic chips CPUs called microprocessors.

It is appreciated that although an illustrative computing environment is shown to comprise the single CPU 110 that such description is merely illustrative, as computing environment 100 may comprise a number of CPUs 110. Additionally, computing environment 100 may exploit the resources of remote CPUs (not shown) through communications network 160 or some other data communications means (not shown).

In operation, the CPU 110 fetches, decodes, and executes instructions, and transfers information to and from other resources via the computer's main data-transfer path, system bus 105. Such a system bus connects the components in the computing system 100 and defines the medium for data exchange. Components that may be connected to the system bus 105 include extension cards, controllers such as a peripherals controller and a memory controller, memory devices such as random access memory (RAM) and read only memory (ROM), and CPU 110.

Further, the computing system 100 may contain network adaptor 170 which may be used to connect the computing system 100 to an external communication network 160. The communications network 160 may provide computer users with connections for communicating and transferring software and information electronically. Additionally, communications network 160 may provide distributed processing, which involves several computers and the sharing of workloads or cooperative efforts in performing a task. It will be appreciated that the network connections shown are exemplary and other means of establishing a communications link between the computers may be used.

It is appreciated that the exemplary computer system 100 is merely illustrative of a computing environment in which the herein described systems and methods may operate and does not limit the implementation of the herein described systems and methods in computing environments having differing components and configurations as the inventive concepts described herein may be implemented in various computing environments having various components and configurations.

Illustrative Computer Network Environment

Computing system 100, described above, can be deployed as part of a computer network. In general, the above description for computing environments applies to both server computers and client computers deployed in a network environment. FIG. 2 illustrates an exemplary illustrative networked computing environment 200, with a server in communication with client computers via a communications network, in which the herein described apparatus and methods may be employed. As shown in FIG. 2, server 205 comprises a computing system 100 that may be interconnected via a communications network 160 (which may be either of, or a combination of a wired or wireless LAN, WAN, intranet, extranet, peer-to-peer network, the Internet, or other communications network) with a number of exemplary client computing environments such as personal computer 100, telephone 215 (such as a wired or mobile telephone), and personal digital assistant 225 (collectively client computing environments 220).

In an exemplary network environment, server 205 is operably connected (such as via communications network 160, or by a link such as an optical, wired, or wireless connection) to a data store 230 for storing data that may be accessed by a computing application 180. The data store 230 can, for example, comprise one or more databases or data warehouses, which may be connected to one or more servers 205. In an illustrative example, a database or data warehouse of data store 230 can comprise any of numerous data sets, and may include historical datasets and reference data sets.

In a network environment in which the communications network 160 is the Internet, for example, server 205 can be one or more dedicated computing environment servers operable to process and communicate data to and from exemplary client computing environments 220 via any of a number of protocols, such as hypertext transfer protocol (HTTP), file transfer protocol (FTP), simple object access protocol (SOAP), wireless application protocol (WAP), etc. Each exemplary client computing environment 220 can be equipped with one or more computing applications 180 operable to gain access to server computing environment 205; for example, computing application 180 may be an operating system, a browser, one or more web applications, or the like.

In operation, a user (not shown) may interact with a computing application 180 running on a client computing environment 220 to obtain desired data and/or computing applications 180, such as from the data store 230. In some implementations, the computing applications 180 may be stored on server computing environment 205 and communicated to cooperating users through exemplary client computing environments 220, over exemplary communications network 160. An exemplary server computing environment 205 may host computing applications, processes and applets for the generation, authentication, encryption, and communication of web services and may cooperate with other server computing environments, service providers, or storage providers (not shown), to realize such web services transactions.

Illustrative Fleet Environment and System Architecture

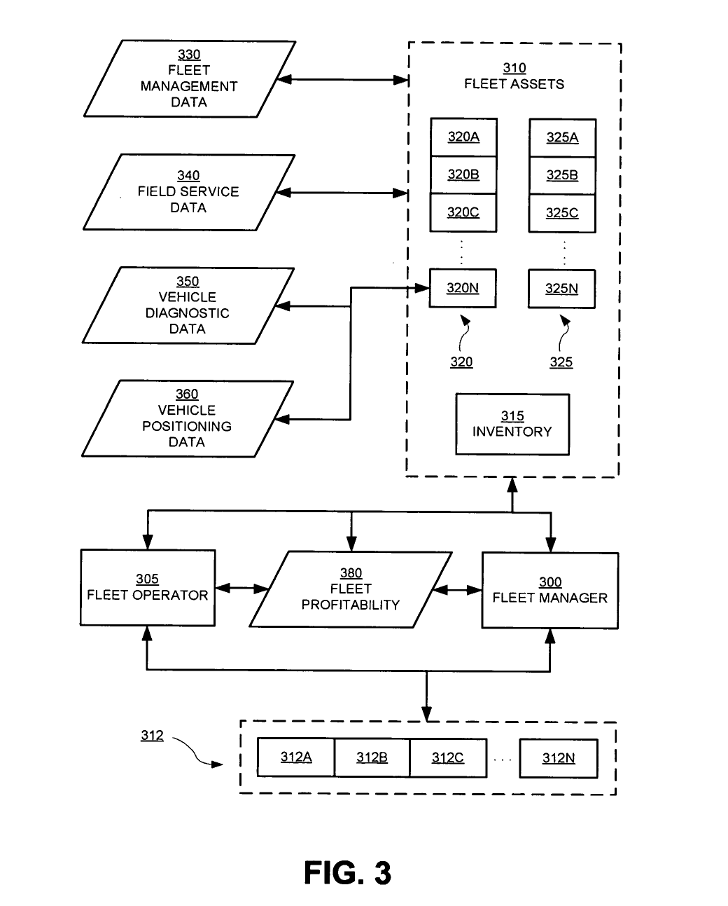

FIG. 3 depicts an illustrative relationship between exemplary fleet assets 310 and exemplary data sets 330-360 for an embodiment of the invention. Fleet assets 310 are owned or operated by a fleet operator 305, and are under or subject to the management of a fleet manager 300. In some embodiments, fleet operator 305 can outsource all or a portion of fleet management responsibilities to a fleet manager 300. In other embodiments, fleet operator 305 and fleet manager 300 can be included in the same business entity or an affiliated business entity; for example, fleet manager 300 can comprise at least one employee, department, division, business unit, or other organizational unit of the fleet operator 305 or its parents, subsidiaries, or corporate affiliates.

The fleet assets 310 include a plurality of vehicles 320A, 320B, 320C . . . 320N (collectively, the fleet 320). The term fleet 320 can encompass a plurality of vehicles 320A-320N owned, or used, by a common entity. The term fleet 320 can encompass a plurality (but not all) of vehicles 320A-320N in the fleet 320, or all of the vehicles 320A-320N in the fleet 320. For example, vehicles 320A-320N within a fleet 320 may be divided into geographical regions, and the use of the term fleet 320 can encompass a collection of vehicles 320A-320N within a region.

The fleet assets 310 can also include a plurality of resources 325A, 325B, 325C . . . 325N (collectively, resources 325) associated with the fleet 320, such as drivers, field service personnel, vehicle maintenance personnel, and other personnel having responsibilities in connection with the fleet 320. Fleet assets 310 can also include inventory 315 which may be associated with the vehicles 320A-320N; for example, inventory 315 can comprise parts or supplies that are stored or transported in the fleet 320, such as for use by field service resources 325 providing services to customers 312. Page: 8

In some embodiments, inventory 315 may be used by field service resources 325 to fix and/or replace products used by customers 312 in the field. Illustrative examples of inventory 315 include spare or replacement parts for fixing a dishwasher, fixing HVAC equipment, and the like. In further embodiments, inventory 315 can include parts, supplies, fuel, and the like, for servicing or maintaining the fleet 320.

The fleet operator 305 may, for example, be a person or business entity that uses the fleet assets 310 to provide services to a plurality of customers 312A . . . 312N (collectively, customers 312). The fleet operator 305, the fleet manager 300, and customers 312 are generally separate persons or business entities; however, they may in some cases be identical or overlapping. For example, in some embodiments, a fleet operator 305 may elect to establish a fleet 320 for internal use of the fleet operator 305; for example, the fleet operator 305 may serve internal customers 312. In further embodiments, customers 312 and/or fleet manager 300 may each represent one or more users, persons, departments, divisions, business units, internal customers, other organizational units of a common entity (such as fleet operator 305) or of separate entities, etc. In some embodiments, the fleet manager 300 and/or the fleet operator 305 may act through personnel (e.g., dispatchers, managers, and the like) who may be included among the resources 325.

In an illustrative example, the vehicles in fleet 320 can include cars, trucks of various classes, vans, and the like; however, in further embodiments, fleet 320 can include other types of vehicles, such as tractor-trailers, aircraft, and emergency response vehicles such as ambulances and fire trucks.

In an illustrative embodiment, the resources 325A-325N and vehicles 320A-320N, and the relationships between and among them, are fleet assets 310 that can be adjusted (e.g., assigned, reassigned, acquired, disposed, dispatched, restricted, constrained by rules, and the like) by the fleet manager 300. For example, the fleet manager 300 may adjust the fleet assets 310 in response to an actionable metric according to an embodiment of the present invention.

Adjusting fleet assets 310 may in some embodiments comprise modifying a use condition of at least one vehicle 320A-320N of the fleet 320. Methods of modifying use conditions on a vehicle 320A-320N can be applied to an individual vehicle 320A or groups of vehicles 320A-320N. Examples of such methods include, but are not limited to: driving a vehicle 320A at a speed below a defined speed, avoiding rapid acceleration or deceleration of the vehicle 320A, avoiding frequent lane changes, driving the vehicle 320A a set distance behind the vehicle ahead of it, driving the vehicle 320A with tire pressure within a set range, driving the vehicle 320A under a set weight limit, and driving a vehicle 320A when the number of driver hours is below an established value over a set time period. Examples of methods of modifying use conditions for the entire fleet 320 of vehicles include, but are not limited to: changing fleet 320 operating procedures to require vehicle operators (e.g., resources 325) to check and maintain tire pressure within a set range, and changing assignments of resources 325 to adjust scheduled driving times of the resources 325 to be under set hours.

The relationships between resources 325A-325N and vehicles 320A-320N are generally one-to-one; however, in some implementations, such relationships can be (for example) one-to-one, one-to-many, many-to-one, zero-to-one, or one-to-zero. In an illustrative example, a resource such as driver 325A may be assigned by the fleet manager 300 to drive a vehicle 320A. In a further example, a particular vehicle 320A may not be assigned to any of the resources 325A-325N, or a particular resource 325A may not be assigned to any of the vehicles 320A-320N, or a particular resource 325A may be assigned to multiple vehicles 320A-320N. In a still further example, a particular resource 325A, such as a mechanic, may be assigned duties (e.g., a maintenance relationship) involving all or a portion of the fleet 320, rather than a single one of the vehicles 320A-320N; meanwhile, a second resource 325B, such as a driver, may be assigned as the current driver of one of the same vehicles 320A-320N that is assigned to the mechanic for maintenance.

Fleet profitability 380 reflects costs and revenues associated with the fleet assets 310, and thereby affects the profitability of fleet-related activities or operations of the fleet operator 305. Fleet profitability 380 may be managed (e.g., measured, analyzed, and/or improved) by fleet manager 300 in any of numerous ways. Improving fleet profitability 380 can include, for example, reducing operating costs for fleet 320, optimizing utilization of the fleet 320 and resources 325, increasing labor productivity of resources 325, reducing labor costs of resources 325, reducing the likelihood of accidents involving one or more vehicles 320A-320N, and reducing costs associated with operating (e.g., driving, fueling, servicing, insuring, leasing, owning, and the like) one or more vehicles 320A-320N. Additional examples of ways to improve fleet profitability 380 include improving satisfaction and/or retention of customers 312, and increasing revenues from services provided to customers 312. Using information provided by aspects of the present invention, a skilled fleet manager 300 can determine adjustments to fleet assets 310 directed toward improving fleet profitability 380. Fleet profitability 380 is generally managed by the fleet manager 300 for the benefit of, or on behalf of, the fleet operator 305.

Fleet management data 330 can be associated with the fleet assets 310; for example, fleet management data 330 can include data describing the fleet 320, the vehicles 320A-320N, the resources 325, the inventory 315, and the relationships among such components of the fleet assets 310.

In some embodiments, fleet management data 330 can include financial information concerning some or all of the vehicles 320A-320N, such as purchase or leasing information, loan amortization information, payoff information, and the like.

In further embodiments, fleet management data 330 can include information concerning fuel consumption for some or all of the vehicles 320A-320N; for example, data collected in connection with the use of a fuel card (e.g., a credit card, debit card, and the like) assigned to one of the resources 325A-325N for use in fueling or servicing one of the vehicles 320A-320N.

In further embodiments, fleet management data 330 can include data sets or data elements provided by a source other than the fleet manager 300; illustrative examples include a fuel card service provider, a provider of financial services, a remarketing service provider (e.g., to provide vehicle prices and information in connection with disposing of an undesired vehicle 320A), an accident services data provider (e.g., to provide vehicle accident data that may be correlated with risky behaviors recorded for any of the vehicles 320A-320N), and a geographic information systems (GIS) or mapping service provider.

In an illustrative example, fleet management data 330 can include data elements pertaining to each of the particular vehicles 320A-320N. In an illustrative example, data elements for a particular vehicle 320A can include a vehicle year (e.g., the model year, or the year of manufacture), vehicle make, vehicle model, and vehicle type (e.g., compact car, sedan, pickup truck, van, SUV, and the like). Fleet management data 330 also can include an identification number (such as a VIN number), a license plate number or other government-issued registration number, and a state or province of registration. Additional fleet management 330 data can include accident information associated with the vehicle 320A, an on road date and an off road date associated with the service of the vehicle 320A in the fleet 320, a gross vehicle weight for the vehicle 320A, a sold date (e.g., for the disposal of the vehicle 320A), and contract information associated with the vehicle 320A. Fleet management data 330 can further include information about one or more resources 325 associated with a vehicle, such as a current driver of the vehicle. Such information can include, for example, a driver identifier (e.g., a current driver's identification number, name, address, phone, email address, and the like). Additional fleet management data 330 can include a garaging address (e.g., a location where the vehicle is parked when not in use, which may correspond to a home or business address of the resource 325).

Field service data 340 can be associated with the fleet assets 310, the fleet 320, and/or with one or more vehicles 320A-320N in the fleet 320. For example, field service data 340 can comprise scheduling information for one or more resources 325 associated with the fleet 320.

In a further example, field service data 340 can include workforce information for any of the resources 325A-325N, such as a worker identifier, worker contact information (e.g., name, address, phone, email address, and the like), assigned vehicle information (e.g., a vehicle identification number for a vehicle 320 for which the resource 325 is the current driver), skills information (e.g., licenses, training, languages spoken), compensation information, availability information (e.g., overtime availability), and certification information. Additional examples of field service data 340 can include job information associated with a job, task, service call, or the like, for which a resource 325A may use a vehicle 320A; for example, a job identifier, a job worker identifier (e.g., uniquely identifying the resource 325A), an estimated job start time, an estimated job end time, an actual job start time, an actual job end time, a job location (e.g., a street address to which the resource 325A will take the vehicle 320A for performance of the job), an estimated and an actual mileage to the job location, and an estimated and actual drive time (e.g., minutes) to the job location. Further illustrative examples of field service data 340 can include route information for one or more of the resources 325, schedule information for one or more of the resources 325, territory information for one or more of the resources 325, dispatcher information, billing information, service center contact information (e.g., an address and/or phone number for a service center location from which resources 325 may be dispatched), appointment information for one or more of the resources 325, calendar information for one or more of the resources 325, services offered information (e.g., specific services offered by one or more resources 325), skills information for one or more of the resources 325, and certification information for one or more of the resources 325.

In some embodiments, field service data 340 can include inventory information associated with the inventory 315, which may be further associated with one or more of the vehicles 320A-320N. In an illustrative example, inventory information can comprise information about parts or supplies stored or transported in one or more of the vehicles 320A-320N, such as for use by field service resources 325. In further embodiments, field services data 340 can include warranty information (date, length of warranty, etc.) for the fleet asset 310 that is being serviced, work process information (such as information in connection with opening and closing a job), problem solution information (e.g., a knowledge database encompassing solutions for problems that may be encountered by a resource 325), training information (e.g., training materials), remote inventory management information, and the like.

Vehicle diagnostic data 350 can be associated with one or more vehicles 320A-320N in the fleet 320. In an illustrative embodiment, the vehicle diagnostic data 350 is preprocessed; that is, vehicle diagnostic data 350 comprises information derived from raw vehicle diagnostic data (e.g., a diagnostic code, such as a diagnostic trouble code or on-board diagnostic code, received from one or more vehicles 320A-320N in the fleet 320). The raw vehicle diagnostic data, prior to being received into the data store 230, may in some embodiments be preprocessed (e.g., interpreted, restated, or otherwise processed) by a third party telematics provider; for example, a telematics provider may interpret a diagnostic trouble code or an on-board diagnostic code, and rather than reporting the actual value of such a diagnostic code, the telematics provider may provide computed or preprocessed vehicle diagnostic data 350 (such as whether the actual value is above or below a predefined value or range). In such embodiments, the fleet manager 300 need not be aware of raw vehicle diagnostic data (such as actual diagnostic codes) that may vary from vehicle 320A to vehicle 320B, or from vehicle manufacturer to manufacturer, or year to year, but may instead rely upon the telematics provider to interpret the raw vehicle diagnostic data.

In another embodiment, the vehicle diagnostic data 350 comprises speed information for a vehicle 320A-320N in the fleet 320. In a further embodiment, the vehicle diagnostic data 350 comprises odometer information for a vehicle 320A-320N in the fleet 320.

Vehicle positioning data 360 can be associated with one or more vehicles 320A-320N in the fleet 320. In some embodiments, vehicle positioning data 360 comprises information describing a geographical location of one or more vehicles 320A-320N within the fleet 320 over time. The geographical location can be obtained by a variety of methods, including a locator that uses a position determining system, such as the Global Positioning System (GPS), Differential GPS (DGPS), Eurofix DGPS, and the Global Navigation Satellite System (GLONASS). Importantly, the present invention is well-suited to use any position determining system (both terrestrial and satellite based) as well as future systems that may be developed, and is not dependent on the use of a particular system. In an illustrative example, vehicle positioning data 360 may be stored in the form of latitude/longitude pairs, and can further comprise (or can be associated with) a date and time, and with one of the vehicles 320A-320N. An exemplary embodiment can store the vehicle positioning data 360 periodically or continuously during a period of time. In an embodiment using the vehicle positioning data 360, a trip map can be generated for any of the vehicles 320A-320N; in a further embodiment, historical routes (e.g., breadcrumb trails showing vehicle positions at periodic intervals) can be mapped for any of the vehicles 320A-320N using a historical data set containing historical vehicle positioning data 360. Similarly, in some embodiments, a speed can be calculated using changes in position over time.

Data sets 330-360 may be maintained in databases, data structures, data warehouses, or files of any kind, such as in data store 230. It is not necessary, in embodiments of the invention, that all of the vehicles 320A-320N will be able to provide vehicle diagnostic data 350, or that all of the vehicles 320A-320N will be able to provide vehicle positioning data 360.

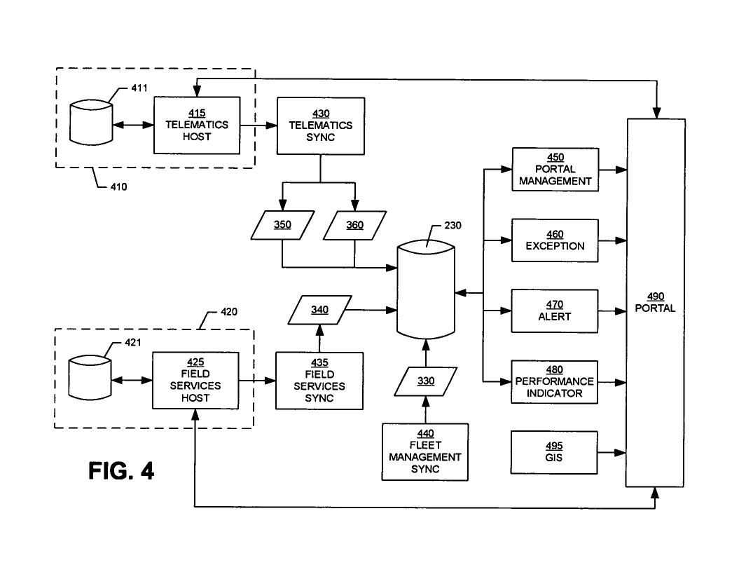

FIG. 4 is a diagram illustrating an exemplary system architecture for an embodiment of the invention. In an illustrative embodiment, data sets 330-360 are received into the data store 230 from one or more sources via synchronization processes 430, 435, 440. A portal 490 is a computing application 180 that is able to provide a user interface (e.g., a fleet interface or a fleet manager interface) for displaying information obtained from the data store 230. In an exemplary embodiment, illustrative features of a portal 490 can include a dashboard-type interface with drill-down capabilities to view individual detail on vehicles 320A-320N, vehicle exceptions 460, vehicle diagnostic alerts 470, performance indicators 480 (e.g., to evaluate overall fleet 320 consumption and operation performance), and visibility of the fleet 320 (such as by using an interactive mapping and tracking tools to view and track vehicles 320A-320N).

The portal 490 may run on one or more servers 205 and/or client computing environments 220 (shown in FIG. 2). In an exemplary embodiment, one or more servers 205 are operably connected to the data store 230, and are able to provide all or a portion of the portal 490 to a client computing environment 220 operated by fleet manager 310. In another embodiment, the portal 490 runs on one or more servers 205, and may be accessed by a client computing environment 220 using a browser software application 180. In a further embodiment, all or a portion of the portal 490 is able to run on a client computing environment 220.

Telematics provider 410 furnishes vehicle diagnostic data 350. Vehicle positioning data 360 can also be furnished by the telematics provider 410, or in some embodiments, may be furnished by a second telematics provider 410. Telematics provider 410 comprises a telematics host 415, such as a server 205 that, in some embodiments, is able to provide web services and/or web applications that may be accessible to portal 490. The telematics host 415 can be directly or indirectly connected, e.g., by one or more communication links that include wireless or satellite communications, to a telematics device (not shown) in any of the vehicles 320A-320N, so that telematics host 415 receives vehicle diagnostic data 350 and/or vehicle positioning data 360 from the vehicles 320A-320N of fleet 320. The telematics host 415 also can be operably connected to a telematics data store 411 that stores vehicle diagnostic data 350 and/or vehicle positioning data 360 received by telematics provider 410 from any of the vehicles 320A-320N.

Telematics provider 410, in some embodiments, can comprise the fleet operator 305, and in some embodiments can comprise the fleet manager 300. In further embodiments, the telematics provider 410 can comprise a service furnished by a vendor to the fleet manager 300. Further examples of a telematics provider 410 that may be suitable for use in embodiments of the present invention include products and services such as Mobile Resource Management (commercially available from @Road, Inc.), Mastertrak (commercially available from Vetronix Corporation), FleetDirector (commercially available from TeleTrac, Inc.), Truck-PC (commercially available from DriverTech), and Networkfleet (commercially available from Networkcar). The telematics host 415 processes raw vehicle diagnostic data that it receives from vehicles 320A-320N, and provides preprocessed vehicle diagnostic data 350 to the data store 230, such as via a telematics synchronization process 430. This advantageous configuration can give a fleet manager 300 or fleet operator 305 the flexibility to use one or more third party telematics providers 410 as part of its integrated fleet solution.

A telematics synchronization process 430 may be provided. In an illustrative embodiment, vehicle diagnostic data 350 and vehicle positioning data 360 are received into the data store 230 from the telematics host 415 via the telematics synchronization process 430. The telematics synchronization process 430 may, for example, provide for data to be pushed from the telematics host 415 to data store 230, or to be pulled from the telematics host 415. An exemplary telematics synchronization process 430 provides the ability for the telematics host 415 to send information upon the occurrence of an event (such as the shutdown of a vehicle 320A-320N), to collect information in real time and to send it at a later time, and to hold data until there is a successful synchronization with the data store 230. A further exemplary telematics synchronization process 430 provides the ability for the portal 490 to send a request to (e.g., to “ping”) a vehicle 320A-320N to obtain current vehicle diagnostic data 350 and vehicle positioning data 360. Yet a further exemplary telematics synchronization process 430 provides the ability for the telematics host 415 to periodically update or refresh the data store 230 with current vehicle diagnostic data 350 and vehicle positioning data 360.

A field services provider 420 comprises a field services host 425, such as a server 205 that, in some embodiments, is able to provide web services and/or web applications that may be accessible to portal 490. The field services host 425 can be operably connected to a field services data store 421 that stores field services data 340.

Field services provider 420, in some embodiments, can be the fleet operator 305, and in other embodiments can be the fleet manager 300. In further embodiments, the field services provider 420 may be a service furnished by a vendor to the fleet manager 300. Further examples of a field services provider 420 that may be suitable for use in embodiments of the present invention include products and services such as workforce management solutions commercially available from Vidus Company, ServicePower, Siebel Systems, Inc., and PointServe, Inc.

In some embodiments of the portal 490, field services provider 420 may provide workforce productivity and/or service delivery optimization features. Illustrative features may include, for example, optimized planning capabilities that may be periodic (e.g., daily, monthly) and/or territory-based, and that may be based on factors such as historical field services data 340, starting and ending locations and driving times for resource 325, projected workload of resources 325, skills sets of resources 325, preferences of customers 312 (e.g., a preferred resource 325, a date/time window, a special skill of resources 325 such as a language capability), preference for continuity of care in sending the same resource 325A to repeatedly visit the same customer 312A, desired visit intervals (e.g., a desired maximum or minimum limitation for recurring visits to a customer 312A), and the like. In further embodiments, illustrative features may include, for example, optimization (e.g., economic optimization, rules-based optimization, or constraints-based optimization) based on customizable business goals and requirements of the fleet operator 305, real-time management for dispatching of resources 325 (e.g., allowing management of same-day changes via scheduling tools and route-based tools, and allowing use of exception-based management), and tools for optimized appointment scheduling for customers 312 to receive services from resources 325 (e.g., allowing customer service representatives of fleet manager 300 to schedule appointments intelligently, capturing customer data for customers 312, offering ranked appointments for selection by customers 312, and allowing confirmation of appointments to be sent to customers 312). In still further embodiments, individual resources 325 can receive assigned orders (e.g., on a printout, online, or via a client computing environment 220 such as a mobile device), which may, for example, include a summary order list, details for each order, an optimized schedule, and maps and driving directions. In additional embodiments, illustrative features that may be provided by field services provider 420 can include warranty management, contract management, remote parts inventory management, and job or work process management (such as information in connection with opening and closing a job),

In further embodiments, a field services provider 420 can include a provider of automation services in connection with logs required by governmental agencies (such as the U.S. Department of Transportation) for commercial drivers such as truckers.

A field services synchronization process 435 may be provided. In an illustrative embodiment, field services data 340 is received into the data store 230 from the field services host 425 via the field services synchronization process 435. The field services synchronization process 435 may, for example, provide for field services data 340 to be pushed from the field services host 425 to data store 230, or to be pulled from the field services host 425. An exemplary field services synchronization process 435 provides the ability for the field services host 425 to send information upon the occurrence of an event, to collect information in real time and to send it at a later time, and to hold data until there is a successful synchronization with the data store 230. A further exemplary field services synchronization process 435 provides the ability for the field services host 425 to periodically update or refresh the data store 230 with current field services data 340.

A fleet manager 300 is able to provide fleet management information 330, e.g., data about fleet assets 310. In some embodiments, all or a portion of the fleet management information 330 may be provided by third parties from whom fleet manager 300 has agreed to receive information.

A fleet management synchronization process 440 may be provided. In an illustrative embodiment, fleet management information 330 is received into the data store 230 from the fleet manager 300 via the fleet management synchronization process 440. The fleet management synchronization process 440 may, for example, provide for fleet management information 330 to be pushed to data store 230, or to be pulled from data store 230. An exemplary fleet management synchronization process 440 provides the ability to send information to data store 230 upon the occurrence of an event, to collect information in real time and to send it at a later time, and to hold data until there is a successful synchronization with the data store 230. A further exemplary fleet management synchronization process 440 provides the ability to periodically update or refresh the data store 230 with current fleet management information 330. In a further embodiment, all or a portion of the fleet management information 330 can be received into the data store 230 via the user interface of the portal 490, or via a different software application 180 (for example, by importing the fleet management information 330 from a file, database, or other data source).

In some embodiments, portal management 450 is provided to implement or manage portions of the portal 490, such as the user interface of the portal 490. Examples of products and services that may be suitable for use in portal management 450 for embodiments of the present invention include PortalBuilder (commercially available from TIBCO Software Inc.), WebLogic Portal (commercially available from BEA Systems, Inc.), and dashboard management products such as Dashboard Manager (commercially available from Business Objects SA). Portal management 450 may, in some embodiments, further comprise reporting functionality for creating, displaying, printing, and/or distributing reports using data elements in data store 230; in such embodiments, examples of further products and services that may be suitable for use in portal management 450 include ReportNet (commercially available from Cognos Inc.), MicroStrategy (commercially available from MicroStrategy Inc.), and WebIntelligence (commercially available from Business Objects SA).

An exception 460, in some embodiments, may be defined using rules (such as business rules) describing a set of conditions (e.g., abnormal or undesired conditions) that generate the exception, and/or describing a set of conditions (e.g., normal or desired conditions) from which a variance will generate the exception.

In some embodiments, examples of an exception 460 can include those described by Tenzer, et al., in the commonly assigned patent application entitled “System and Method for Identifying Undesired Vehicle Events,” having attorney docket no. 202817, and which application is incorporated herein by reference in its entirety.

An alert 470, in some embodiments, comprises notification concerning an exception 460 that has been selected (e.g., by the fleet manager 300 or the fleet operator 305) for special or individualized attention. For example, some kinds of exception 460 may be sufficiently serious that immediate notification of selected individuals is desired. In an illustrative example, if a vehicle 320A experiences a problem that triggers a diagnostic trouble code, the telematics provider 410 may cause the telematics synchronization process 430 to send vehicle diagnostic data 350 to the portal 490 that triggers an exception 460, and such an exception 460 may generate an alert 470. In some embodiments, the notification provided by the alert 470 may simply comprise prominent display or placement in the user interface of portal 490. In further embodiments, an alert 470 may be associated with providing notice to persons associated with the fleet manager 300 or the fleet operator 305, such as by generating an automatic email, message, or report.

A performance indicator 480, in some embodiments, is a quantifiable measurement or statistical metric, selected to reflect an organizational goal or success factor of the fleet operator 305 or fleet manager 300, or otherwise having a bearing upon fleet profitability 380. In further embodiments, a performance indicator 480 generally is a long-term consideration that may be measured over an extended period of time. In an embodiment of the invention, performance indicator 480 is calculated using data elements associated with at least two data sets selected from the group consisting of fleet management data 330, field service data 340, and either vehicle diagnostic data 350 or vehicle positioning data 360. In further embodiments, performance indicator 480 may be calculated using any of numerous other combinations of data elements from data sets 330-360 and/or other data sources.

In an illustrative embodiment, a performance indicator 480 may be a statistical metric describing an asset optimization opportunity. Illustrative examples of an asset optimization opportunity include a fuel savings opportunity, a number of unused or idle vehicles in the fleet 320, a percentage of unused or idle vehicles in the fleet 320, a distance driven per time period (e.g., miles driven per month), a drive time per time period (e.g., hours driven per day), a number of stops per time period (e.g., stops per day), an operating cost per distance unit (e.g., operating cost per mile), and an emission compliance metric (e.g., a percentage of vehicles in the fleet 320 that are compliant with selected or governmentally-required emissions rules). In some embodiments, examples of a performance indicator 480 can include user-defined statistical metrics as described by Tenzer, et al., in the commonly assigned patent application entitled “A System and Method for Identifying Fuel Savings Opportunity in Vehicles,” having attorney docket no. 202815, and which application is incorporated herein by reference in its entirety.

In a further illustrative embodiment, a performance indicator 480 may be a statistical metric describing a safety condition or a security condition. Illustrative examples of a security condition include a vehicle compliance metric (e.g., a percentage of vehicles in the fleet 320 that are compliant with selected rules, such as legal rules, and fleet policies established by fleet manager 300 or fleet operator 305). Illustrative examples of a safety condition include an accident rate (e.g., a percentage of vehicles in the fleet 320 that have experienced an accident), an accident cost per distance unit (e.g., accident cost per miles driven by the fleet 320). In some embodiments, examples of a performance indicator 480 can include user-defined statistical metrics as described by Passman, et al., in the commonly assigned patent application entitled “A System and Method for Identifying Operational Usage of Fleet Vehicles Related to Accident Prevention,” having attorney docket no. 202816, and which application is incorporated herein by reference in its entirety.

Some embodiments are able to use a geographic information system (GIS) 495 to furnish graphical location information (e.g., mapping and tracking services) for fleet assets 310 through the portal 490; for example, to provide a map that shows the location of a vehicle 320A using vehicle positioning data 360 associated with the vehicle 320A. Examples of GIS 495 that may be suitable for use in embodiments of the present invention include products and services such as ArcGIS (commercially available from Environmental Systems Research Institute, Inc.), Advantage (commercially available from MapQuest, Inc.), and MapServ, TrackServ, and/or ActiveMap (all commercially available from Maptuit Corporation).

Exemplary Portal

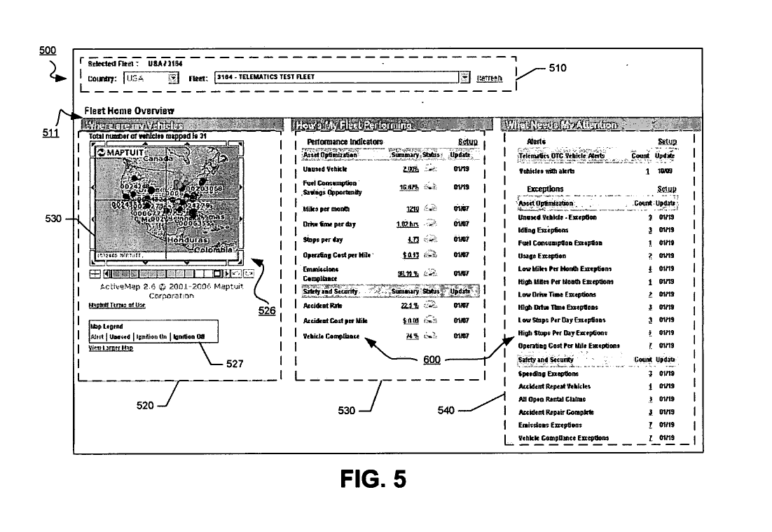

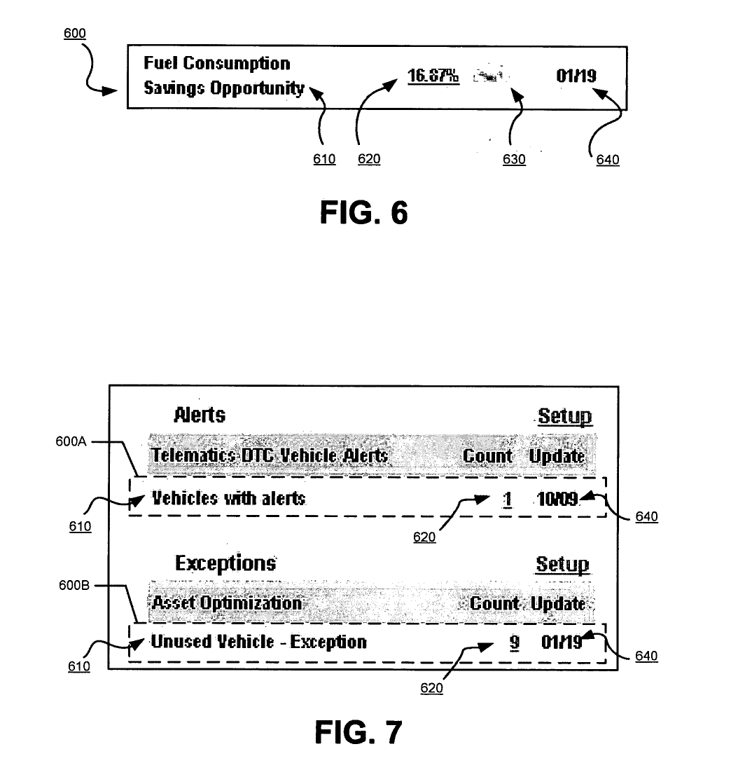

FIG. 5 shows an exemplary user interface 500 for portal 490, in an embodiment of the invention. The portal 490 is able to provide a fleet manager interface, such as user interface 500, for displaying one or more actionable metrics 600 and other information to a user. The user may be, for example, any of fleet manager 300, personnel or resources 325 associated with fleet manager 300, or personnel or resources 325 associated with fleet assets 310. An exemplary portal 490 may use one or more web applications, web services, and the like, for displaying the actionable metrics 600 and other information. Illustrative examples of actionable metrics 600 are shown in detail in FIG. 6 and FIG. 7 and discussed below. While the drawings and specific examples given describe an exemplary embodiment of the portal 490, it will be understood that they serve the purpose of illustration only, and the invention is not limited to the precise screens, controls, design features, configurations, and arrangements depicted.

In some embodiments, any of numerous titles, headings, or other informational elements, such as headings 511, may be provided in the user interface 500, e.g., to identify areas of the display. In still further embodiments, the user interface 500 can include navigation controls (not shown) for navigating to various functions, screens, or windows of the portal 490 or to another computing application 180. Additional information in the user interface 500 may include column headings or other descriptive matter, hypertext links, and the like.

In further embodiments, fleet selection controls 510 may be provided. Fleet selection controls 510 comprise a user interface for performing illustrative functions such as selecting a fleet 320, a subset or subfleet of the fleet 320, a geographic or geopolitical region (e.g., country, state, province), or any of numerous other possible parameters or constraints upon the information presented in the portal 490.

A mapping region 520 is provided in some embodiments. An exemplary mapping region 520 can include a map 525 and map controls 526, for displaying mapping and/or tracking information associated with GIS 495. An exemplary map 525 may display representations of the location of all or a portion of the fleet 320, based on the vehicle positioning data 360. Exemplary map controls 526 may allow the user to control functions such as zooming in or out (e.g., moving between a street-level view and a city-level view), panning, and other functions useful for controlling the map 525. In some embodiments, GIS 495 may provide a web application, web service, or the like, for displaying the map 525 and providing map controls 526. In further embodiments, map 525 may use differing shapes, colors, or other distinguishing features to represent vehicles 320A-320N in differing states (e.g., red for a vehicle 320A that has generated an alert 470, blue for an unused vehicle 320B, green for a vehicle 320C with ignition on, and black for a vehicle 320D with ignition off). The mapping region 520 may in some embodiments include additional information, such as one or more legends 527 for describing features of the map 525 and/or map controls 526. Additional information in an exemplary mapping region 520 may also include column headings or other descriptive matter, navigation controls, hypertext links, and the like.

A performance indicator region 530 is provided in an embodiment. An exemplary performance indicator region 530 can include one or more actionable metrics 600 that are associated with a performance indicator 480. An illustrative example of an actionable metric 600 associated with a performance indicator 480 is shown in detail in FIG. 6. Additional information in performance indicator region 530 may include column headings or other descriptive matter, navigation controls, hypertext links, and the like.

An exception indicator region 540 is provided in an embodiment. An exemplary exception indicator region 540 can include one or more actionable metrics 600 that are associated with an exception 460 or with an alert 470. Illustrative examples of actionable metrics 600 associated with an exception 460 or with an alert 470 are shown in detail in FIG. 7. Additional information in an exemplary exception indicator region 540 may include column headings or other descriptive matter, navigation controls, hypertext links, and the like.

FIG. 6 shows an exemplary actionable metric 600 for a performance indicator 480, displayable by a portal 490 in an embodiment of the invention.

An actionable metric 600, in some embodiments, comprises information presented through the portal 490 describing a performance indicator 480, alert 470, or exception 460, such that a fleet manager 300 can act upon the information therein, e.g., by clicking to see details, or by taking steps to adjust fleet assets 310 in response to the information.

In one embodiment, an exemplary actionable metric 600 includes a description 610 (e.g., a label, heading, or other identifying or descriptive information) associated with the performance indicator 480. In the example shown in the drawings, description 610 is a text field displaying the words “Fuel Consumption Savings Opportunity.”

The exemplary embodiment includes a value 620 of the performance indicator 480 associated with the actionable metric 600. The value 620, for example, may be displayed as a number, count, percentage, or in any other useful form or format.

In some embodiments, the actionable metric 600 further includes a status indicator 630, displaying a status of the performance indicator 480 associated with the actionable metric 600. In the example shown in the drawings, status indicator 630 is a graphical representation of a meter or gauge. The illustrative status indicator 630 includes a representation of a needle that points to the left, center, or right (representing a value 620 that may be deemed low, normal, or high by fleet manager 300). In addition, some embodiments of status indicator 630 can use colors to provide useful information (e.g., colors such as red, yellow, and green may respectively indicate values 620 that may be deemed by fleet manager 300 to relate to a high level of concern, a lesser level of concern, and a normal condition). However, any of numerous other types of status indicators 630 may be used; or in some embodiments, no status indicator 630 may be provided.

In further embodiments, currency information 640 is provided to indicate whether the actionable metric 600 displays a current value 620 for the performance indicator 480. In the illustrative example shown in the drawings, currency information 640 is a date on which the value 620 was last updated. However, in further embodiments, currency information 640 may provide information such as a date, time, descriptive text, or a status indicator 630 to convey how recently the last update took place. Currency information 640 may relate to updates to the value 620, to data elements used to calculate the performance indicator 480, or to the calculation of the performance indicator 480. In some embodiments, no currency information 640 may be provided.

In some embodiments, the user may select a portion of the actionable metric 600 to trigger a display of more detailed information concerning the performance indicator 480. In an illustrative example, the user may select the value 620 (e.g., by clicking with a mouse or pointer device on a value 620 that is displayed by the portal 490 as a hyperlink), causing the portal 490 to display more detailed information concerning the performance indicator 480.

FIG. 7 shows an exemplary actionable metric 600A for an alert 470, and an exemplary actionable metric 600B for an exception 460, displayable by a portal 490 in an embodiment of the invention. In the illustrated example, a portion of exception indicator region 540 is shown.

For an exemplary actionable metric 600A for an alert 470, in the example shown in the drawings, description 610 is a text field displaying the words “Vehicles with alerts,” and value 620 is a count of the number of vehicles 320A-320N for which a diagnostic trouble code alert 470 has been triggered by the telematics provider 410. In the illustrative example shown in the drawing, if a vehicle 320A experiences a problem that triggers a diagnostic trouble code, the telematics provider 410 may cause the telematics synchronization process 430 to send vehicle diagnostic data 350 to the portal 490 that triggers an exception 460. Such an exception 460 may generate the diagnostic trouble code alert 470, resulting in an increment to the value 620 for the actionable metric 600A, and in some embodiments resulting in updated currency information 640 for the actionable metric 600A.

For an exemplary actionable metric 600B for an exception 460, in the example shown in the drawings, description 610 is a text field displaying the words “Unused Vehicle—Exception,” and value 620 is a count of the number of vehicles 320A-320N for which an unused vehicle exception 460 has been triggered. Each unused vehicle exception 460 may result in an increment to the value 620 for the actionable metric 600B, and in some embodiments further results in updated currency information 640 for the actionable metric 600B.

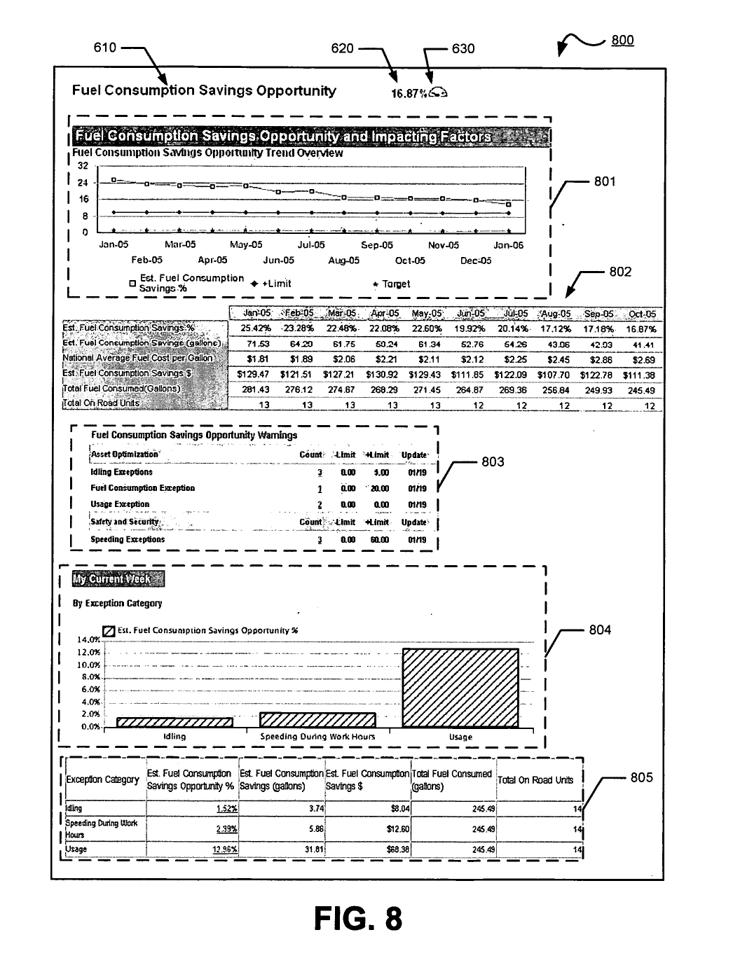

FIG. 8 shows an exemplary detail screen 800 displayable by a portal 490 in an embodiment of the invention. In the example shown in the drawings, the detail screen 800 provides details for a performance indicator 480 for a fuel consumption savings opportunity. In this illustrative example, the user may have reached detail screen 800 from the actionable metric 600 shown in FIG. 6 above; e.g., by selecting the value 620 (e.g., by clicking with a mouse or pointer device on a value 620 that is displayed by the portal 490 as a hyperlink), causing the portal 490 to display detail screen 800.

Any of numerous details may be provided in embodiments of a detail screen 800. In an illustrative embodiment, exemplary details 801-805 are provided to show the user detailed information about a fuel consumption savings opportunity performance indicator 480.

A trend is shown in exemplary detail 801; for example, the trend may be depicted in the form of a line graph showing the value 620 over a period of time. Further lines in the exemplary line graph of detail 801 can depict a limit and a target for value 620. In an illustrative embodiment, the average value 620 may be calculated and graphed as a data point for a unit of time such as a month.

A table of data elements over a period of time is shown in exemplary detail 802; for example, the table may show data elements used in the calculation of performance indicator 480. In an illustrative example, the average value of such data elements may be calculated and provided as a data point for a unit of time such as a month.

A table of exceptions 460 is shown in exemplary detail 803; for example, a display like that of exception indicator region 540 may be provided. Further information provided in embodiments of exemplary detail 803 can provide information on lower and/or upper limits to the value 620 associated with the exception 460.

A bar graph of components of the performance indicator 480 over a period of time is shown in exemplary detail 804; for example, for the current week, the bar graph can depict portions of the fuel consumption savings opportunity performance indicator 480 that are attributable to idling, speeding during work hours, and usage of a vehicle 320.

A second table of data elements is shown in exemplary detail 805; for example, the table may show data elements that may be calculated using performance indicator 480. In an illustrative example, the second table can show how the value 620 of the fuel consumption savings opportunity performance indicator 480 can be translated to fuel savings in gallons and dollars, for each of several categories of savings opportunity (e.g., idling, speeding during work hours, and usage of a vehicle 320).

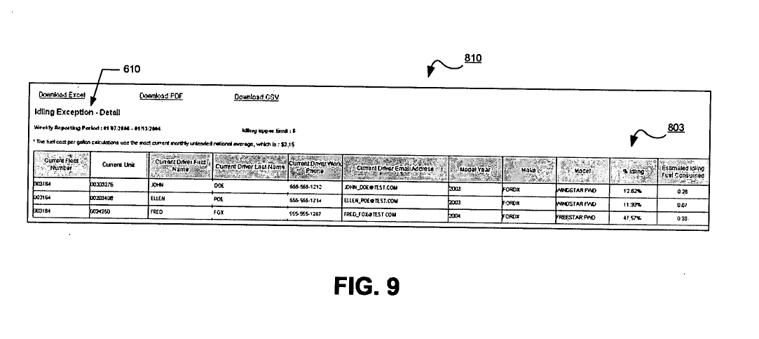

FIG. 9 shows an exemplary detail screen 810 associated with an exception report for an exception 460, displayable by a portal 490 in an embodiment of the invention. Exemplary detail 803 comprises the exception report; in an illustrative example, the exception report may be an illustrative table of exceptions 460 associated with one or more idling exceptions 460. Further information provided in embodiments of exemplary detail 803 can include information on lower and/or upper limits to the value 620 associated with the exception 460. Detail screen 810 may include user interface controls for downloading the exception report (e.g., as a spreadsheet, as a PDF file, and as a file of comma separated values).

In the illustrated embodiment, the exemplary detail 803 can include selected data elements pertaining to each idling exception 460, such as a current fleet number, a current service unit (e.g., a service center for managing resources 325), contact information for a current driver 325 associated with the exception 460 (e.g., first and last names, work phone number, email address), vehicle information associated with the exception 460 (e.g., make, model, model year), a value 620 associated with the exception 460 (e.g., percent idling), and one or more data elements that may be calculated using the value 620 (e.g., estimated idling fuel consumed).

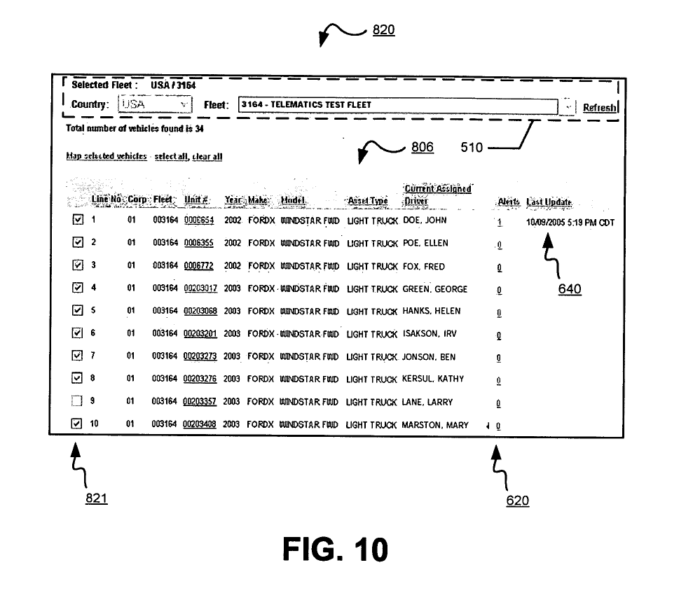

FIG. 10 shows an exemplary detail screen 820 associated with an asset listing for fleet assets 310, displayable by a portal 490 in an embodiment of the invention. Exemplary detail 806 comprises the asset listing. Further information provided in embodiments of exemplary detail screen 820 can include, for example, fleet selection controls 510, and user interface controls 821 (e.g., checkboxes, hyperlinks, and the like) for selecting fleet assets 310 such as any of vehicles 320A-320N, and for generating a map of the selected fleet assets 310.

In the illustrated embodiment, the exemplary detail 806 can include selected data elements pertaining to each of the vehicles 320A-320N, such as a line number, corporation number (e.g., for fleet operator 305), current fleet number, a current unit number (e.g., a subfleet or a service center for managing resources 325), vehicle information (e.g., model year, make, model, asset type), contact information for a current driver 325 associated with the exception 460 (e.g., first and last names, work phone number, email address), a value 620 associated with any vehicle alert 470 triggered, and currency information 640.

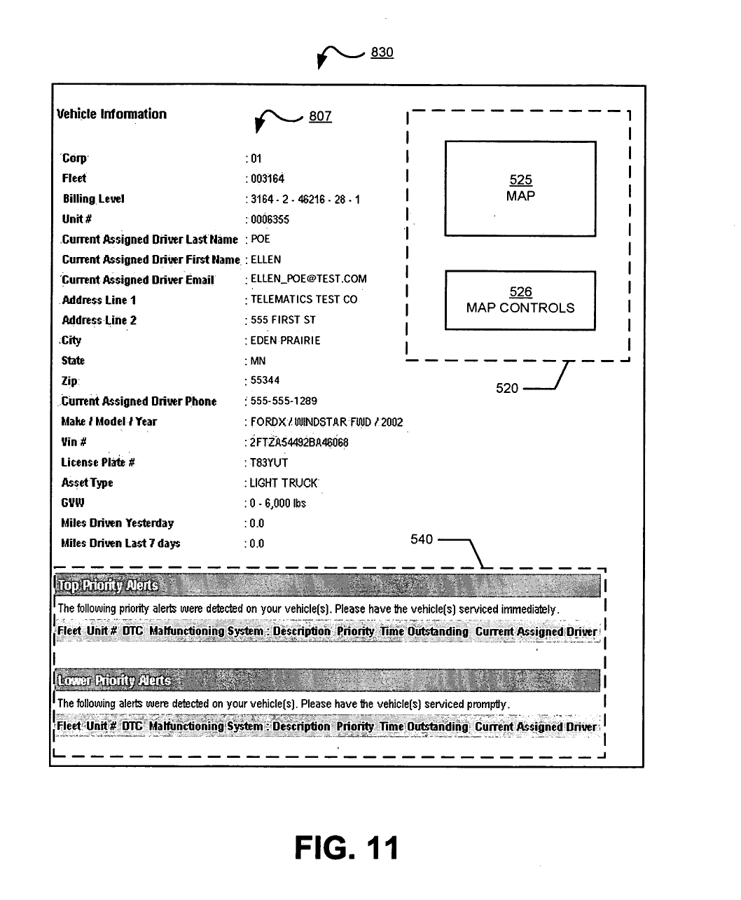

FIG. 11 shows an exemplary detail screen 830 associated with a selected fleet asset 310, displayable by a portal 490 in an embodiment of the invention. Exemplary detail 807 for vehicle 320A comprises vehicle information. Further information provided in embodiments of exemplary detail screen 830 can include, for example, exemplary mapping region 520. Exemplary mapping region 520 can include a map 525 and map controls 526, for displaying mapping and/or tracking information associated with the selected vehicle 320A. In some embodiments, detail screen 830 may be displayed by portal 490 in response to a user selection (e.g., by clicking or otherwise selecting a button, hyperlink, or the like) corresponding to one of the vehicles 320A-320N displayed on another screen such as detail screen 320.

In the illustrated embodiment, the exemplary detail 807 can include selected data elements pertaining to the selected vehicles 320A-320N, such as a corporation number (e.g., for fleet operator 305), fleet number, billing level, unit number (e.g., a subfleet or a service center for managing resources 325), contact information for a current driver 325 associated with the exception 460 (e.g., first and last names, mailing address, email address, telephone number), vehicle information (e.g., model year, make, model, vehicle identification number, license plate number, asset type, gross vehicle weight), and further data elements associated with the vehicle 320A, such as distance units driven during a period of time (e.g., miles driven yesterday, miles driven last seven days).

In the illustrated embodiment, the exemplary detail 807 can further include an exception indicator region 540. In some embodiments, exception indicator region 540 can include one or more actionable metrics 600 that are associated with alerts 470 for the vehicle 320A, and in further embodiments, such actionable metrics 600 may be prioritized based upon priority (e.g., top priority and lower priority alerts 470).

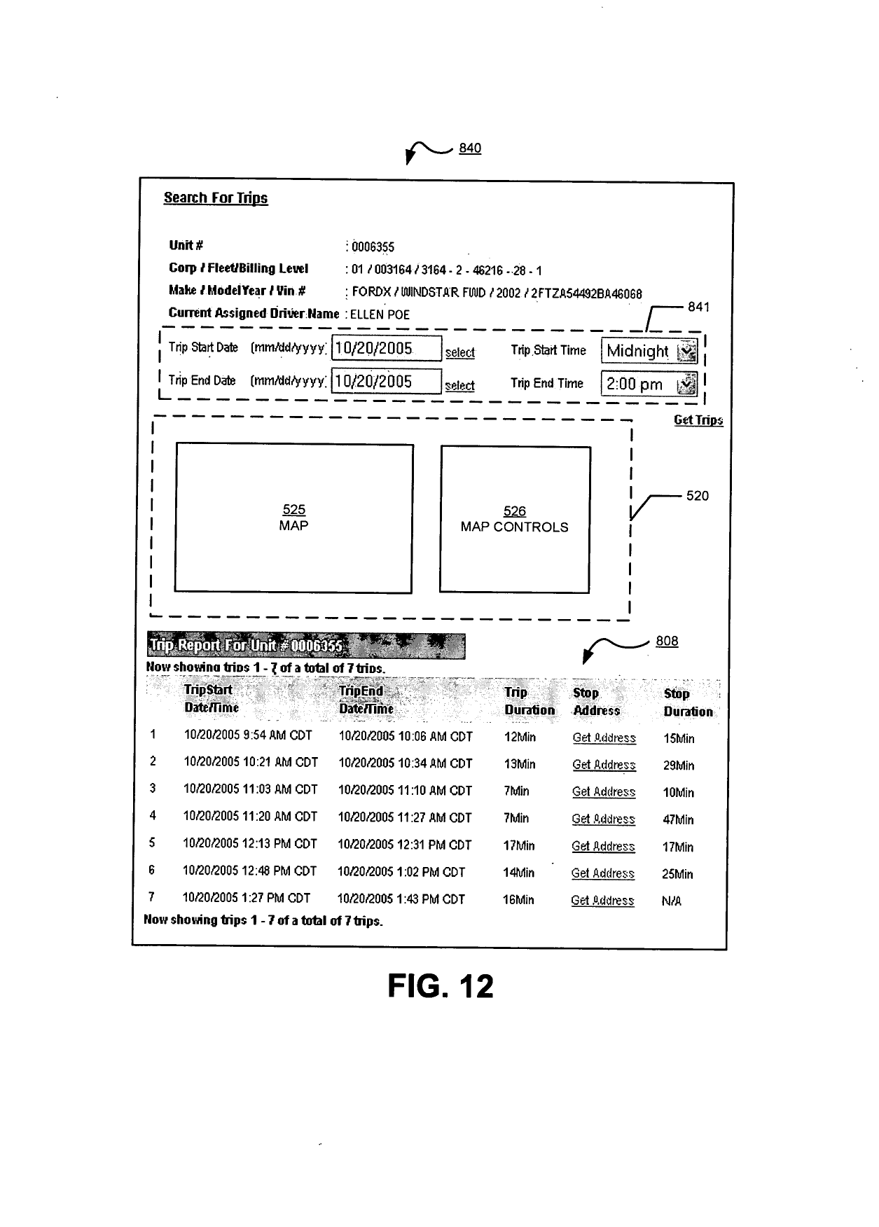

FIG. 12 shows an exemplary detail screen 840 associated with trip mapping for a selected fleet asset 310, displayable by a portal 490 in an embodiment of the invention. In the illustrated embodiment, the selected fleet asset 310 is a vehicle 320A; however, other types of fleet assets 310 may be mapped. Exemplary detail 808 comprises trip information for selected vehicle 320A for a period of time. Exemplary detail screen 840 can include a selection region 841 for selecting a time period (e.g., starting and ending dates, starting and ending times) for constraining the amount of trip information to be displayed in detail 808. Further information provided in embodiments of exemplary detail screen 840 can include, for example, vehicle information for the selected vehicle 320A, and an exemplary mapping region 520. Exemplary mapping region 520 can include a map 525 and map controls 526, for displaying mapping and/or tracking information associated with the trip information for selected vehicle 320A.

Exemplary Method

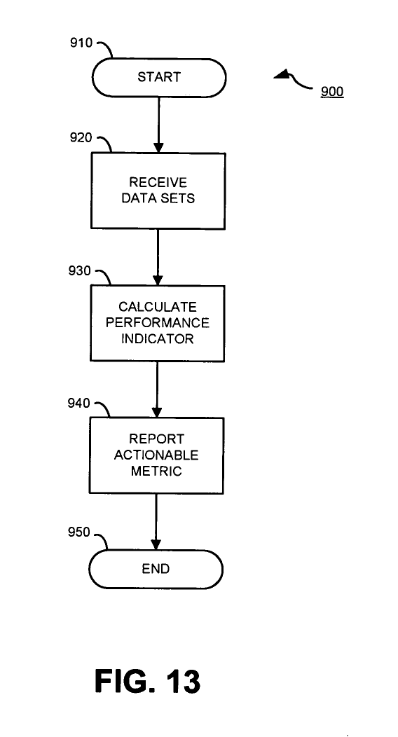

FIG. 13 shows a method 900 for monitoring an actionable metric 600 associated with a fleet, according to an embodiment of the present invention. The method 900 begins at start block 910, and proceeds to block 920.

At block 920, data sets 330-360 are received. The data sets 330-360 comprise fleet management data 330, field service data 340, and either vehicle diagnostic data 350 or vehicle positioning data 360. It is not necessary that any or all of the vehicles 320A-320N will be able to provide vehicle diagnostic data 350, or that any or all of the vehicles 320A-320N will be able to provide vehicle positioning data 360. Accordingly, the vehicle diagnostic data 350, if received, is for at least a first portion of the plurality of vehicles 320A-320N in the fleet 320, and the vehicle positioning data 360, if received, is for at least a second portion of the plurality of vehicles 320 in the fleet 320.

At block 930, a performance indicator 480 is calculated. An exemplary calculation of a performance indicator 480 in an embodiment is described by Tenzer, et al., in the commonly assigned patent application entitled “A System and Method for Identifying Fuel Savings Opportunity in Vehicles,” having attorney docket no. 202815, and which application is incorporated herein by reference in its entirety. An exemplary calculation of a performance indicator 480 in a further embodiment is described by Passman, et al., in the commonly assigned patent application entitled “A System and Method for Identifying Operational Usage of Fleet Vehicles Related to Accident Prevention,” having attorney docket no. 202816, and which application is incorporated herein by reference in its entirety.

At block 940, an actionable metric 600 is reported by the portal 490. In some embodiments, the portal 490 reports the actionable metric 600 on a dashboard-type display, as discussed above with reference to FIG. 6. The method 900 concludes at block 950.

### ILLUSTRATIVE EXAMPLES

The following examples, which are not limiting, illustrate aspects of the invention. For example, the examples demonstrate how, in an illustrative embodiment, the fleet manager 300 can adjust the fleet assets 310 based upon the actionable metric 600. In a further embodiment, the adjustment can be directed toward improving fleet profitability 180.

### Example 1

A fleet manager 300 has a large and dispersed fleet 320, and needs to determine which vehicles 320A-320N are idle, and where these vehicles 320A-320N are. In an illustrative embodiment, an exception 460 (which may be generated in real-time) can identify an unused or idle vehicle 320A of the fleet 320 to the fleet manager 300. A performance indicator 480 for unused vehicles may be calculated using the exception 460; for example, the value of the performance indicator 480 may be the number of vehicles 320A-320N or the percentage of the fleet 320 that is unused or idle. Based upon the exception 460 and/or the performance indicator 480, the portal 490 displays an actionable metric 600 to the fleet manager 300. The fleet manager 300, using the portal 490, can make a user selection (e.g., by clicking on a portion of the actionable metric 600), where the user selection is associated with a detail of the actionable metric 600. Upon receiving the user selection, the portal 490 reports the detail (such as by presenting an exception report).

Using the information presented in the actionable metric 600 and/or the detail, the fleet manager 300 can adjust the fleet assets 310, for example, by redeploying or selling the idle vehicle 320A. In a further embodiment, a fleet manager 300 may have access to real-time and/or historical diagnostic information that can be leveraged to obtain recommendations on the best time to sell the idle vehicle 320A. Fleet profitability 180 may be improved by saving money through active management of idle fleet assets 310, providing high potential cost savings. Rather than the arduous process previously required to identify and locate idle fleet assets 310, fleet manager 300 can obtain real-time access to determine in-use vs. idle fleet assets 310.

### Example 2

When a vehicle 320A is driven to a fuel station to fill up, the driver 325A uses a fuel card (e.g., a credit or debit card). In some embodiments, the driver 325A may provide an authorization code and odometer reading to the fuel card provider. The location of the fuel station may be known to the fuel card provider. Prior to authorization of the transaction by the fuel card provider, the actual location of the vehicle 320A is compared to the location of the fuel station. If the locations do not substantially match, fraud is identified; for example, the vehicle 320A may be at its garaging location (e.g., home in the garage of the driver 325A), while the driver 325A attempts to use the fuel card to fuel a second vehicle (e.g., a personally-owned vehicle of the driver 325A). If fraud is identified, the fuel card provider can decline to authorize the transaction, and place a security watch on future usage of the fuel card; in addition, the fuel card provider can cause a fleet management synchronization process 440 to send fleet management data 330 to the portal 490 that triggers an exception 460. The portal 490 will display an actionable metric 600 for the exception 460. The exception 460 may generate an alert 470, and in some embodiments, an email may be sent to the driver 325A's manager and/or to fleet manager 300.

Using the information presented in the actionable metric 600 and/or the detail, the fleet manager 300 can adjust the fleet assets 310, for example, by assigning the driver 325A to different duties, or by taking appropriate steps that may result in suspending or terminating employment of the driver 325A, or by reassigning the vehicle 320A to another driver 325B-325N. In some embodiments, fleet profitability 180 can be improved through immediate fuel fraud detection and prevention of the transaction, as well as through deterrence of future fraud.

### Example 3

A fleet manager 300 faces a queue of field service jobs, calls, or orders, and is responsible for deploying a fleet 320 of service vehicles 320A-320N, resources 325 (e.g., technicians), and inventory 315. Historically, technicians have been assigned to jobs on a first-available first-assigned basis, which produced suboptimal results such as unnecessarily high costs. Using information presented in an actionable metric 600, schedules and routes may be optimized by the fleet manager 300 in real-time, based on data elements such as locations of the vehicles 320A-320N, replacement part inventory 315 on a vehicle 320A, skill sets of the technician 325, shortest routes to the job, and the like. Fleet profitability 180 may be increased by saving money through route optimization (e.g. decreased mileage driven) and schedule optimization (e.g., more jobs per technician 325 per day), while improving customer service levels by guaranteeing the right technician 325 with the right skill sets, having the right inventory 315 (e.g., parts) at the right time.

### Example 4

A fleet operator 305 has experienced an unusually high at-fault accident rate, or a high breakdown or unplanned maintenance rate for the fleet 320. Driver behavior is the most critical factor contributing to at-fault accidents and unplanned maintenance. Safety exceptions 460 can be defined to identify factors such as operation of a vehicle at excessive speed, excessive acceleration, excessive braking, improper seat belt usage, too-frequent lane changing, tailgating, excessive speed in turns, high RPM, clutch patterns, and the like. Using an actionable metric 600 for a vehicle safety index exception 460, specific problematic resources 325 can be identified.

Using the information presented in the actionable metric 600 and/or the detail, the fleet manager 300 can adjust the fleet assets 310; for example, by implementing custom training programs for unsafe drivers 325, or by making unsafe drivers 325 aware of the potential to minimize accidents by not operating a vehicle 320A under unsafe conditions. Accidents and breakdowns can thereby be reduced, leading to significant savings in direct expenses from the accidents or breakdowns, and other savings such as insurance costs, affecting fleet profitability 180. Detail may be reported to the fleet manager 300 pertinent to driver safety, at-fault accidents, and unplanned maintenance control reports; such information can enable the fleet manager 300 to track cost savings affecting fleet profitability 180.

### Example 5

Vehicle diagnostic data 350 is received, indicating that an oil life sensor shows 90% life used, indicating a need to change oil in vehicle 320A. An exception 460 or alert 470 is triggered, notifying a mechanic (e.g., a mechanic associated with the fleet manager 300). The mechanic can send an inquiry to the vehicle 320A to identify other potential maintenance issues or opportunities.

Based on the diagnosis of the mechanic made using vehicle diagnostic data 350, plus fleet management information 330 relating to the schedule and/or location of the vehicle 320A and driver 325, as well as information concerning repair facilities (e.g., national account database and national account scheduling systems), the vehicle 320A can be automatically scheduled for maintenance or repair at an optimal time and location. Fleet profitability 380 can be improved through optimizing preventative maintenance, national account utilization, and automating the scheduling of the maintenance into the daily schedule of the vehicle 320A.

### Example 6

Vehicle diagnostic data 350 is received, indicating that a “check engine” light is illuminated in vehicle 320A. An alert 470 is triggered, notifying a mechanic (e.g., a mechanic associated with the fleet manager 300). The mechanic can send an inquiry to the vehicle 320A to identify other potential maintenance issues or opportunities, and to diagnose the problem.

In an illustrative example, if the vehicle 320A is not under warranty, the fleet management data 330 can so inform the mechanic. Based on the diagnosis of the mechanic made using vehicle diagnostic data 350, plus fleet management information 330 relating to the schedule and/or location of the vehicle 320A and driver 325, as well as information concerning repair facilities (e.g., national account database and national account scheduling systems), the vehicle 320A can be scheduled for repair at an optimal time and location. The mechanic can call the driver 325, using contact information in the fleet management information 330, and can direct the driver 325 to the selected repair facility with specific service instructions. In some embodiments, fleet manager 300 may be informed by email of resolution of the issue. Fleet profitability 380 can be improved through optimizing preventative maintenance, national account utilization, and automating the scheduling of the maintenance into the daily schedule of the vehicle 320A. In the example, proactive diagnostic monitoring can result in an avoided breakdown, and a national account repair facility can provide the lowest price, thereby improving fleet profitability 180.

### Example 7

A vehicle 320A goes in for service, and the service station calls the fleet manager 300 for authorization. A mechanic associated with the fleet manager 300 can send an inquiry to the vehicle 320A to gather vehicle diagnostic data 350 (e.g., current diagnostic and sensor data). The mechanic can check the appropriateness of any recommendations of the service station (e.g., identifying an up-sell situation), and can approve appropriate service work orders. Fleet profitability 180 is enhanced by enabling the mechanic or fleet manager 300 to better negotiate with a service station.

Although exemplary implementations of the invention have been described in detail above, those skilled in the art will readily appreciate that many additional modifications are possible in the exemplary embodiments without materially departing from the novel teachings and advantages of the invention. Accordingly, these and all such modifications are intended to be included within the scope of this invention. The invention may be better defined by the following exemplary claims.

What is claimed is:

1. A method for monitoring an actionable metric associated with a fleet, comprising:
receiving a first data set comprising fleet management data for the fleet, receiving a second data set comprising field service data associated with the fleet,
receiving a third data set comprising at least one data set selected from a group consisting of a set of vehicle diagnostic data and a set of vehicle positioning data,
calculating a performance indicator using data elements associated with at least two data sets selected from the group consisting of the first, second, and third data sets, and
reporting an actionable metric based upon the performance indicator.

2. The method of claim 1 further comprising adjusting fleet assets based upon the actionable metric.

3. The method of claim 2 wherein adjusting the fleet assets is directed toward improving fleet profitability based upon the actionable metric.

4. The method of claim 1 wherein reporting further comprises providing a web application for displaying the actionable metric.

5. The method of claim 1 wherein reporting further comprises providing a portal for displaying the actionable metric.

6. The method of claim 1 wherein reporting further comprises
accepting a user selection associated with the actionable metric, and reporting the detail.

7. The method of claim 1 further comprising modifying a use condition of the fleet based upon the actionable metric.

8. The method of claim 1 further comprising modifying a use condition of at least one vehicle of the fleet based upon the actionable metric.

9. The method of claim 1 wherein the actionable metric comprises a description of the performance indicator.

10. The method of claim 1 wherein the actionable metric comprises a value of the performance indicator.

11. The method of claim 1 wherein the actionable metric comprises a status indicator associated with a value of the performance indicator.

12. The method of claim 1 wherein the actionable metric comprises a graph associated with one or more values of the performance indicator over time.

13. The method of claim 1 wherein the actionable metric comprises currency information associated with the performance indicator.

14. The method of claim 1 wherein receiving the field service data comprises synchronizing the field service data with a field service provider.

15. The method of claim 1 wherein receiving the vehicle diagnostic data comprises synchronizing the vehicle diagnostic data with a telematics provider.

16. The method of claim 1 wherein receiving the vehicle positioning data comprises synchronizing the vehicle positioning data with a telematics provider.

17. The method of claim 1 further comprising graphically reporting the vehicle positioning data.

18. The method of claim 1 wherein the performance indicator describes an asset optimization opportunity.

19. The method of claim 1 wherein the performance indicator describes a member of the group consisting of fuel savings opportunity, unused vehicles, distance per time period, drive time per time period, stops per time period, operating cost per distance unit, and emission compliance.

20. The method of claim 1 further comprising
triggering an exception,
wherein calculating the performance indicator is further based upon a data element associated with the exception.

21. The method of claim 20 further comprising reporting a second actionable metric based upon the exception.

22. The method of claim 20 wherein the exception relates to a member of the group consisting of fuel savings opportunity, unused vehicles, distance per time period, drive time per time period, stops per time period, operating cost per distance unit, and emission compliance.

23. The method of claim 1 further comprising reporting a second actionable metric based upon an alert.

24. The method of claim 23 wherein the alert describes vehicle diagnostic data relating to one or more vehicles of the fleet.

25. The method of claim 1 wherein the actionable metric describes a safety condition relating to one or more vehicles of the fleet.

26. The method of claim 1 wherein the actionable metric describes a security condition relating to one or more vehicles of the fleet.

27. The method of claim 1 wherein the performance indicator describes a member of the group consisting of accident rate, accident cost per distance unit, and vehicle compliance.

28. The method of claim 1 wherein the fleet management data comprises vehicle information for each of a plurality of vehicles in the fleet.

29. The method of claim 28 wherein the vehicle information comprises at least one data element selected from the group consisting of vehicle year, make, model, vehicle type, identification number, license plate number, state of registration, accident information, on road date, off road date, gross vehicle weight, sold date, contract information, driver identifier, and garaging address.

30. The method of claim 1 wherein the field service data comprises scheduling information for one or more resources associated with the fleet.

31. The method of claim 1 wherein the field service data comprises at least one data element selected from the group consisting of workforce information, job information, route information, schedule information, inventory information, territory information, dispatcher information, billing information, service center contact information, appointment information, calendar information, services offered information, skills information, certification information, warranty information, work process information, problem solution information, training information, and remote inventory management information.

32. The method of claim 31 wherein workforce information comprises at least one data element selected from the group consisting of worker identifier, worker contact information, assigned vehicle information, skills information, compensation information, availability information, and certification information.

33. The method of claim 31 wherein job information comprises at least one data element selected from the group consisting of job identifier, job worker identifier, estimated job start time, estimated job end time, actual job start time, actual job end time, job location, estimated mileage to job location, and estimated drive time to job location.

34. The method of claim 1 wherein the vehicle diagnostic data comprises preprocessed information derived from raw vehicle diagnostic data received from a vehicle in the fleet.

35. The method of claim 1 wherein the raw vehicle diagnostic data comprises a diagnostic code for a vehicle in the fleet.

36. The method of claim 1 wherein the vehicle diagnostic data comprises speed information for a vehicle in the fleet.

37. The method of claim 1 wherein the vehicle diagnostic data comprises odometer information for a vehicle in the fleet.

38. The method of claim 1 wherein the vehicle positioning data comprises global positioning satellite data for a vehicle in the fleet.

39. A system for monitoring an actionable metric associated with a fleet, comprising:
a computer and a data store operably connected to the computer,
the data store comprising
a first data set comprising fleet management data for the fleet,
a second data set comprising field service data associated with the fleet, and
a third data set comprising at least one data set selected from a group consisting of a set of vehicle diagnostic data, and a set of vehicle positioning data,
the computer being adapted to calculate a performance indicator using a plurality of data elements associated with at least two data sets selected from the group consisting of the first, second, and third data sets, and further adapted to report at least one actionable metric comprising the performance indicator.

40. The system of claim 39 further comprising a web application operable on the computer for displaying the actionable metric.

41. The system of claim 39 further comprising a portal operable on the computer for displaying the actionable metric.

42. The system of claim 39 wherein the actionable metric comprises a description of the performance indicator.

43. The system of claim 39 wherein the actionable metric comprises a value of the performance indicator.

44. The system of claim 39 wherein the actionable metric comprises a status indicator associated with a value of the performance indicator.

45. The system of claim 39 wherein the actionable metric comprises a graph associated with one or more values of the performance indicator over time.

46. The system of claim 39 wherein the actionable metric comprises currency information associated with the performance indicator.

47. The system of claim 39 wherein the computer is further adapted to synchronize the field service data with a field service provider.

48. The system of claim 39 wherein the computer is further adapted to synchronize the vehicle diagnostic data with a telematics provider.

49. The system of claim 39 wherein the computer is further adapted to synchronize the vehicle positioning data with a telematics provider.

50. The system of claim 39 wherein the computer is further adapted to graphically report the vehicle positioning data.

51. The system of claim 39 wherein the performance indicator describes an asset optimization.

52. The system of claim 39 wherein the performance indicator describes a member of the group consisting of fuel savings opportunity, unused vehicles, distance per time period, drive time per time period, stops per time period, operating cost per distance unit, and emission compliance.

53. The system of claim 39 wherein the computer is further adapted to report a second actionable metric based upon an exception.

54. The system of claim 53 wherein the exception relates to a member of the group consisting of fuel savings opportunity, unused vehicles, distance per time period, drive time per time period, stops per time period, operating cost per distance unit, and emission compliance.

55. The system of claim 39 wherein the computer is further adapted to report a second actionable metric based upon an alert.

56. The system of claim 55 wherein the alert describes vehicle diagnostic data relating to one or more vehicles of the fleet.

57. The system of claim 39 wherein the performance indicator describes a safety condition relating to one or more vehicles of the fleet.

58. The system of claim 39 wherein the performance indicator describes a security condition relating to one or more vehicles of the fleet.

59. The system of claim 39 wherein the performance indicator describes a member of the group consisting of accident rate, accident cost per distance unit, and vehicle compliance.

60. The system of claim 39 wherein the fleet management data comprises vehicle information for each of a plurality of vehicles in the fleet.

61. The system of claim 60 wherein the vehicle information comprises at least one data element selected from the group consisting of vehicle year, make, model, vehicle type, identification number, license plate number, state of registration, accident information, on road date, off road date, gross vehicle weight, sold date, contract information, driver identifier, and garaging address.

62. The system of claim 39 wherein the field service data comprises logistics information.

63. The system of claim 39 wherein the field service data comprises at least one data element selected from the group consisting of workforce information, job information, route information, schedule information, inventory information, territory information, dispatcher information, billing information, service center contact information, appointment information, calendar information, services offered information, skills information, certification information, warranty information, work process information, problem solution information, training information, and remote inventory management information.

64. The system of claim 63 wherein workforce information comprises at least one data element selected from the group consisting of worker identifier, worker contact information, assigned vehicle information, skills information, availability information, and certification information.

65. The system of claim 63 wherein job information comprises at least one data element selected from the group consisting of job identifier, job worker identifier, estimated job start time, estimated job end time, actual job start time, actual job end time, job location, estimated mileage to job location, and estimated drive time to job location.

66. The system of claim 39 wherein the vehicle diagnostic data comprises preprocessed information derived from raw vehicle diagnostic data received from a vehicle in the fleet.

67. The system of claim 39 wherein the raw vehicle diagnostic data comprises a diagnostic code for a vehicle in the fleet.

68. The system of claim 39 wherein the vehicle diagnostic data comprises speed information for a vehicle in the fleet.

69. The system of claim 39 wherein the vehicle diagnostic data comprises odometer information for a vehicle in the fleet.

70. The system of claim 39 wherein the vehicle positioning data comprises global positioning satellite data for a vehicle in the fleet.

71. A computer-readable medium containing a set of instructions for monitoring an actionable metric associated with a fleet, the set of instructions comprising steps for:
receiving a first data set comprising fleet management data for the fleet,
receiving a second data set comprising field service data associated with the fleet,
receiving a third data set comprising at least one data set selected from a group consisting of a set of vehicle diagnostic data, and a set of vehicle positioning data,
calculating a performance indicator using data elements associated with at least two data sets selected from the group consisting of the first, second, and third data sets, and
reporting the actionable metric based upon the performance indicator.

72. A system for monitoring an actionable metric associated with a fleet, comprising:
a computer,
a data store operably connected to the computer,
a first means for receiving a first data set comprising fleet management data for the fleet,
a second means for receiving a second data set comprising field service data associated with the fleet,
a third means for receiving a third data set comprising at least one data set selected from a group consisting of a set of vehicle diagnostic data and a set of vehicle positioning data,
means for calculating a performance indicator using data elements associated with at least two data sets selected from the group consisting of the first, second, and third data sets, and
means for reporting the actionable metric based upon the performance indicator.
